(19) United States
(12) Patent Application Publication
(10) Pub. No.: US 2005/0161015 A1
(43) Pub. Date: Jul. 28, 2005

(54) Interchangeable 2-stroke or 4-stroke high torque power engine

(76) Inventor: Robert Louis Giuliani, Honolulu, HI (US)

Correspondence Address: R.L. GIULIANI, A-1204, 1456 THURSTON AVE, HONOLULU, HI, 96822, US

(21) Appl. No.: 11/083,789

(22) Filed: Mar. 18, 2005

Related U.S. Application Data
(63) Continuation-in-part of application No. 10/935,402, filed on Sep. 7, 2004, now abandoned.
Application No. 10/935,402 is a continuation-in-part of application No. 10/643,274, filed on Aug. 18, 2003, now abandoned.
Application No. 10/643,274 is a continuation-in-part of application No. 10/252,927, filed on Sep. 24, 2002, now abandoned.

(51) Int. Cl. F02B 75/32

(52) U.S. Cl. 123/197.1

(57) ABSTRACT

This is a high torque power, offset piston engine with a straight power shaft. It is interchangeable between a 2-stroke and a 4-stroke by easily repositioning an idler. Objects of this invention include:
1. easily interchanged between 2-stroke and 4-stroke; 2. instant peak torque at the beginning of the power stroke; 3. power stroke overlap; 4. piston always square in its cylinder reduces cylinder wear and bypass gases; 5. an efficient 1-way clutch transmits power to the power shaft; 6. the 1-way clutch overrun feature allows deactivating pairs of pistons without load on the shaft; 7. lightweight piston and rod due to compression forces only; 8. low cylinder expansion rate with a small bore, which allows more complete combustion of a small combustion charge resulting in high fuel efficiency; 9. reduced mass engine compared to a crank engine; 10. fewer main bearings due to shear force only on the power shaft.

### CROSS-REFERENCE TO RELATED APPLICATIONS

Not applicable.

### FEDERALLY SPONSORED RESEARCH OR DEVELOPMENT

Not applicable.

This is a continuation-in-part application of CIP application Ser. No. 10/935,402 filed Sep. 7, 2004.

### BACKGROUND OF THE INVENTION

Engines that transmit an offset piston's power to a straight power shaft have been attempted since at least 1921, e.g. U.S. Pat. No. 1,365,666 but have not had practical success though they inherently offer high torque and high fuel efficiency. Their weakness lies in using many energy absorbing moving parts and combustion chambers to convert the piston's reciprocating rectilinear motion to the power shaft's unidirectional rotary motion which has made them inefficient and impractical, e.g. U.S. Pat. Nos. 2,239,663; and 5,673,665. For this reason, the simple, exhaust polluting, inefficient but reliable crank engine survives as the search for a better power source continues.

Enormous finds and research have been poured into fuel cells, electric vehicles and crank engine hybrids for years in an unsuccessful effort to replace the ubiquitous crank engine.

The crank engine is very inefficient because the two angles at both ends of the connecting rod of length L and the crank angle α (FIG. 10) combine to slow the piston's speed, which traps the very rapidly expanding combustion gases in a small chamber. The gases build up very high heat and pressure at and near tdc. Here, nearly all the force from the pressure is vectored against the crankshaft's bearings instead of rotating it. Parts inertia is combined with extra fuel on each power stroke to overcome the angles' resistance. The result is excess exhaust pollution and waste heat. The waste heat is lost and the pollutants are partly scrubbed from the exhaust when it is too late.

The pollution and the waste heat must be reduced in the combustion chamber by converting them to mechanical motion with a more complete burn. To do that, all the rod and crank angles must be zero during the entire power stroke but that is impossible in a crank engine. The following mathematics explain why:

FIG. 10 is a schematic that represents a crank engine. FV1, FV2, FV3 are force vectors that come from burn pressure driving the piston 38. FV1 is along a radial of the crankshaft axis C. Only FV3, being tangent to the crank circle d, rotates the shaft where FV3=FV1(Cos θ)(Cos Φ). The crank engine's efficiency is zero at tdc when angle θ=0° but angle Φ=90°, making FV3=FV1(1)(0)=0. When FV2 is tangent to circle d, Cos Φ=1.0 and Tan θ=r/L and θ=Tan⁻¹r/L from which Cos θ is found. The efficiency at that point is FV3/FV1=Cos θ. The importance of angle θ=Tan⁻¹r/L will be shown below.

The ratio of the displacement M along the crank circle d to the piston's displacement a at any chosen crank angle α is easily found from FIG. 10. r is the crank arm length and α is in degrees:
r=b+a
a=r(1−Cos α)
M=παr/180
M/a=πα/[180(1−Cos α)]
For instance, when α=10°, M/a=11.49:1. At this point, the rod's slow crank end must go 11.49 times as far as the piston. The slower the crank's rotation, the longer the gases are trapped in a small chamber and the lower the engine's efficiency. It is known that this is where the confined hot, pressurized gases create most of the pollution and waste heat. The crank's angular efficiency:
Cos θ=FV2/FV1
Cos Φ=FV3/FV2
FV2=FV1(Cos θ)
FV2=FV3/Cos Φ
FV3=FV1(Cos θ)(Cos Φ)
FV3/FV1=(Cos θ)(Cos Φ) Crank engine's angular efficiency. It caps thermal efficiency.

FIG 10 is also the basis for the following indented equations that lead to the Cos θ and Cos Φ equations in terms of crank angle α, length L and crank arm r:
180−β=γ
γ+θ+Φ=180
β=90−α Note the rt. triangle (α+β+90)
180−(90−α)=γ or 90+α=γ
(90+α)+θ+Φ=180
α+θ+Φ=90
n=r Sin α
Sin θ=(r/L)Sin α
θ=Sin⁻¹[(r/L)Sin α]
Cos θ=Cos{Sin⁻¹[(r/L)Sin α]}
α+Sin⁻¹[(r/L)Sin α]+Φ=90
Φ=90−{α+Sin⁻¹[(r/L)Sin α]}
Cos Φ=Cos(90−{α+Sin⁻¹[(r/L)Sin α]})
The equations Cos θ, Cos Φare easily solved with a hand calculator. For instance, they give the angular efficiency=22.4% when α=10°; r=1.5″ L=5.0″ Since the thermal efficiency is low (See M/a above) the total efficiency has to be much less than 22.4% in this example. The efficiency increases as α increases but the combustion pressure decreases as α increases. A higher rpm increases efficiency but that has reached its limit and it is not good enough.

The importance of angle θ=Tan⁻¹r/L now follows. That is when FV2 is tangent to the circle d at the arm r which makes angle Φ=0.0 and Cos φ=1.0. The angular efficiency is Cos θ=Cos(Tan⁻¹r/L). In the example above where r=1.5″; L=5.0″ FV3/FV1=Cos θ=95.8%. Extend L relative to r so that angle θ goes to 0.0. Then

$${Lim}_{θ \to 0.0} Cos θ = 1.0 .$$

Lim Cos θ=1.0. (This is the foundation for calculus). That makes the angular efficiency FV3/FV1=(Cos θ)(Cos Φ)=(1)(1)=100% because there is no angular resistance since the angles θ,Φ disappear. The variable angle α disappears. The crank arm r disappears. The variable length torque arm n (FIG. 10) which requires torque buildup is replaced by the fixed length torque arm r′ (FIG. 11) which gives instant peak torque.

Unlike the crank, FV1 in this invention (FIG. 11) is always directed to rotating the output shaft 8 rather than directed against the shaft's bearings. FV1 is transmitted with both angles θ,Φ=0.0 through the entire power stroke. The M/a=1:1 through the entire stroke. The circumference d′ replaces the crank circle d in FIG. 10. Motion is transmitted through the fixed length torque arm r′ to the output shaft 8.

### BRIEF SUMMARY OF THE INVENTION

This is a high torque power engine that can be easily switched between a 2-stroke and a 4-stroke. A pair of combustion cylinders and their related pairs of parts, including 1-way clutches, are connected by an idler gear to make the basic 2-stroke engine. Computer controlled ignition between two basic engines allows power stroke overlap by equally spaced-apart pistons. A third idler connects two basic engines to make a 4-stroke engine. The crankshaft is replaced by a straight power shaft.

A 1-way clutch transmits power between the power piston and the output shaft. The piston is offset from the shaft at the point where it engages the piston rod. A suggested 1-way clutch that efficiently transmits torque is described in my U.S. Pat. No. 6,571,925 dated Jun. 3, 2003. This clutch will be emphasized over commercial 1-way clutches although commercial clutches are mentioned since they can be used with limitations.

One of the benefits of this engine is overlapping power strokes. For example: a 2-stroke, 6 cyl engine with a 9″ piston stroke would simultaneously have the 1^{st} piston 6″ after tdc, the 2^{nd} piston 3″ after tdc and the 3^{rd} piston igniting at tdc. The 6 pistons continuously cycle through their power strokes in this sequence. The power added by the 3^{rd} piston is reduced by the combined remaining power of the 1^{st} and 2^{nd} pistons resulting in fuel savings and smooth power shaft rotation.

Objects of this invention include:
1. easily interchanged between 2-stroke and 4-stroke;
2. no mechanical limit to the piston stroke allows sizing a more efficient combustion chamber;
3. offset pistons give instant peak torque at the beginning of the power stroke;
4. the 1-way clutch overrun feature allows deactivating pairs of pistons without load on the shaft;
5. reduced mass engine compared to a crank engine;
6. lightweight piston and rod due to compression forces only;
7. piston always square in its cylinder reduces cylinder wear and bypass gases;
8. power stroke overlap;
9. thin, straight power shaft due to shear force only;
10. fewer main bearings due to shear force only on the power shaft.

### BRIEF DESCRIPTION OF THE DRAWINGS

The rack 58 is wide in the drawings to easily distinguish it from the connected piston rod 18.

Chamber 33 is shown small bore, long stroke to emphasize its sizing for best combustion range.

FIG. 1 is a side view of the basic 2-cylinder 2-stroke engine with the alternative 1-way clutch.

FIG. 2 details the mechanism between the alternative 1-way clutch and a spline power shaft.

FIG. 3 shows a commercial 1-way clutch combined with a rack and spur gear pinion.

FIG. 4 shows how motion is transmitted between a piston and a 1-way clutch through a gear mesh.

FIG. 5 shows how a belt or a chain replaces the gear mesh in FIG. 4.

FIG. 6 shows a means for decelerating and reversing pistons at the end of the stroke.

FIG. 7 is a schematic of two computer controlled pairs of pistons for a 2-stroke.

FIG. 8 shows a 4-stroke engine by combining two 2-stroke pairs with a special idler 40A.

FIG. 9 focuses on separation of idler 40A from the sector gears in FIG. 8 to create two 2-Strokes.

FIG. 10 is a schematic of a crank engine used for mathematical reference in the text above.

FIG. 11 is a schematic of this invention used to compare with FIG. 10.

### DETAILED DESCRIPTION OF THE INVENTION

FIG. 3 shows a commercial 1-way clutch 59 that supports a spur gear 61. This clutch is keyed directly to the power shaft 8. A rack gear 58, part of piston rod 18, powers the spur gear pinion which rotates the shaft 8 through the clutch 59. A sector gear 12 meshes with idler gear 40 and idler 40 meshes with a second gear 12 carried by a second spur (not shown) to timely advance the second out of phase piston on its stroke. The guide 21 (FIGS. 1,4,5,8) can be applied to this version. Further description of this version is believed to encumber this disclosure with the obvious.

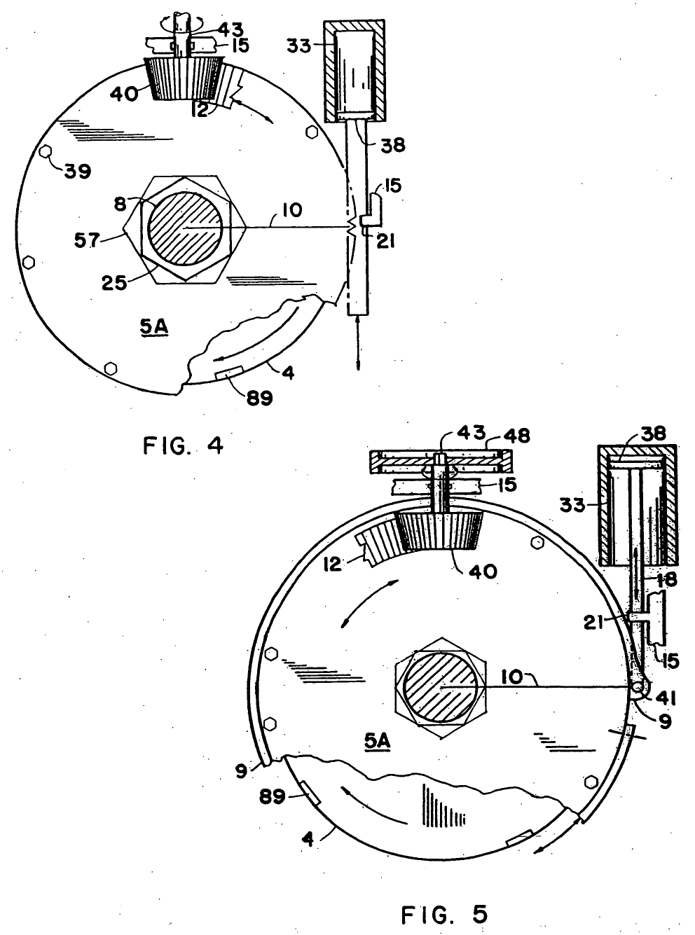

A detailed description of an alternative 1-way clutch is believed unnecessary because it is detailed with drawings in my U.S. Pat. No. 6,571,925 titled, “1-Way Clutch That Uses Levers”. Reference will be made to it and the way it can support this engine. The basic 1-way clutch in my patent is modified to fit this engine (FIGS. 1,4,5) by securing two side plates 5A and 5C to the outer race 5B with bolts 39. The plates secured to each of two clutches carry a sector gear 12 that meshes with opposite sides of an idler 40 (FIGS. 1,4,5) to make the basic 2-stroke engine in this invention. There are gaskets between the three parts to prevent oil from entering. The combustion chambers 33, shown 90° from vertical (FIGS. 4,5), can be slanted between 90° and 180° to direct cylinder lube oil flow away from the clutch.

In the alternative clutch, torque transmitting units 89 are placed at the rim of hub 4 (FIGS. 4,5). The farther from shaft 8 axis, the lower the torque force which reduces stress on the parts. Compare to the location of a conventional 1-way clutch (FIG. 3).

My transmitting unit 89 has a lever arm that contacts the outer race 5B to transmit the torque to the hub 4. Hub 4 transmits the torque to the power shaft 8. A pin brings the surfaces into contact to transmit the torque and a spring brings them out of contact during overrun. The contact surfaces are described as high friction in my U.S. Pat. No. 6,571,925 but this is modified here with a commercial belt adhered to race 5B and an array of short, pointed spikes or hooks on the lever's contact surface that instantly grip the belt during drive and disconnect during overrun. The spikes on the pin continue in sliding contact with the belt to detect motion change in outer race 5B and tilts the arm to cause the contact. The contact surface of a modified lever arm bridges the space between the belt and the hub to transmit torque directly to the hub 4 very efficiently. The number of transmitting units depends upon the force applied to race 5B. Units 89 are in a cartridge for easy replacement.

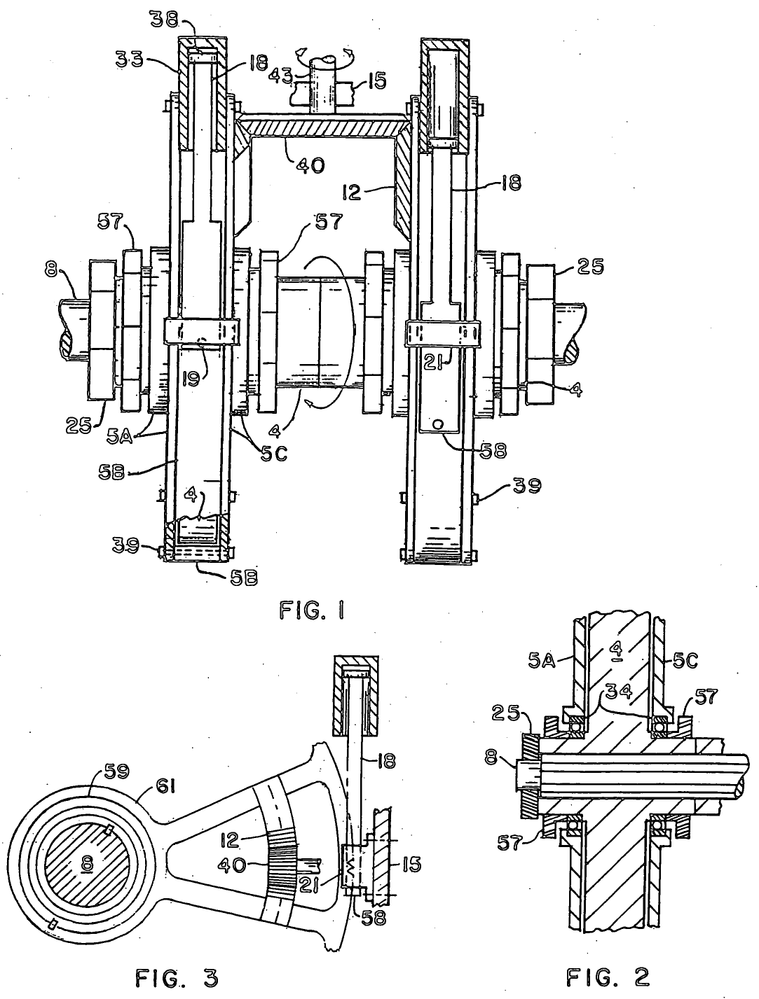

The alternative clutch's hub 4 is keyed or splined (FIG. 2) to the power shaft 8 and rotates in one direction. Retaining nuts 25, threaded to the two ends of shaft 8, prevent axial movement of the 1-way clutch assemblies. If a spline shaft is used, the diameter of its two end parts stops at the base of the splines to allow placement and removal of hub 4 from shaft 8. There is a narrow space between nut 25 and the splines so that full nut 25 force is applied to the hub 4 at both shaft ends. Retaining nuts 57, threaded to hub 4, prevent independent motion of the inner races of bearings 34. Plates 5A and 5C keep the outer races of bearings 34 in place. Each gear 12 engages an opposite side of idler 40 (FIGS. 1,8) which causes synchronous timing motion between the pair of out-of-phase power pistons 38 as the hub 4 (FIG. 2) transmits unidirectional drive to the shaft 8. The combined parts operate as a strong, tight, efficient unit.

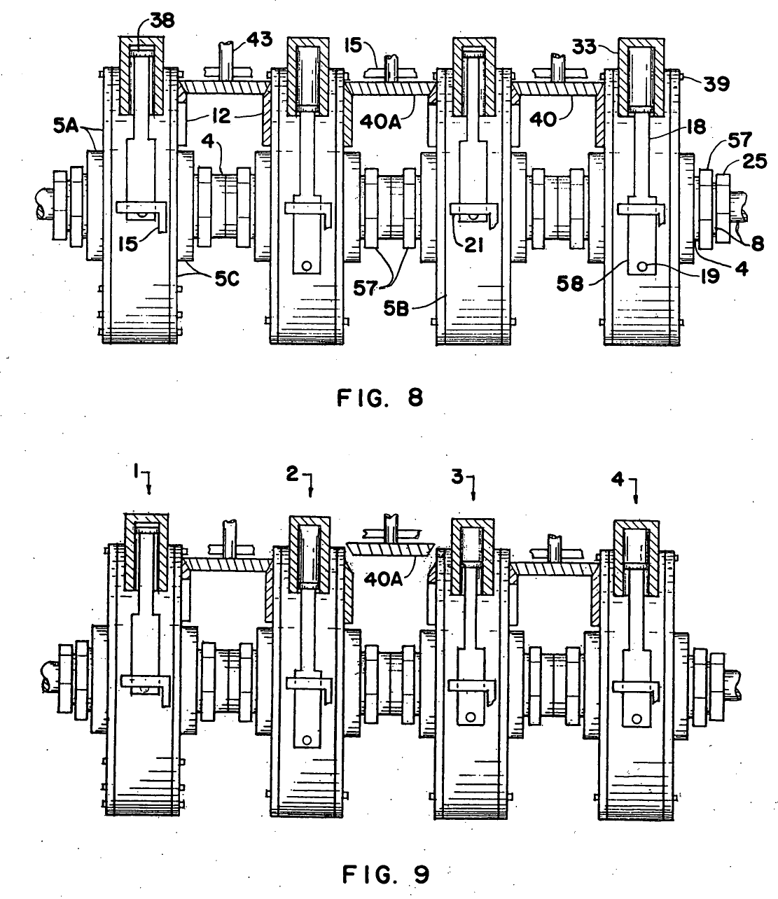

Combining two pairs with idler 40A creates a 4-stroke shown in FIG. 8 that will be described below under Interchanging 4-Stroke and 2-Stroke.

A rack gear 58 (FIGS. 1,3,4,8,9) transmits the piston power from piston rod 18 to the outer race 5B of the 1-way clutch. A suitable guide 21, secured to housing 15, keeps the rack 58 aligned with the race 5B. A second guide applied to rod 18 near the combustion chamber 33 may be needed to prevent tooth wear on the rack and pinion.

In a second configuration for a 2-stroke (FIG. 5), one end of a belt 9 or a chain 9 is fastened to the outer race 5B. The way it is wrapped around race 5B always keeps it taut, which prevents backlash as it rotates race 5B in response to the power stroke. Rod 18 is connected to the other end of the belt or chain 9 with a suitable fastener 41.

The alternative 1-way clutch's overrun feature in this engine allows output shaft 8 and the clutch hub 4 to rotate independently of the pistons 38 when the hub speed is greater than the outer race 5B speed. This feature in both versions (FIGS. 2,3) can convert braking energy to regenerated energy stored in an energy storage device 28 (FIG. 7) available, e.g. for demand dumping to shaft 8.

The fixed length torque arm 10 (FIGS. 4,5) in this offset piston design causes instant peak torque at the beginning of the power stroke (FIG. 11 FV1) so shear force only is applied to the shaft 8. Shear force without radial force permits a thin, straight shaft 8 (FIGS. 1,4,5,8,9) and smaller main bearings where the bearings in many cases can be limited to one at each end of shaft 8.

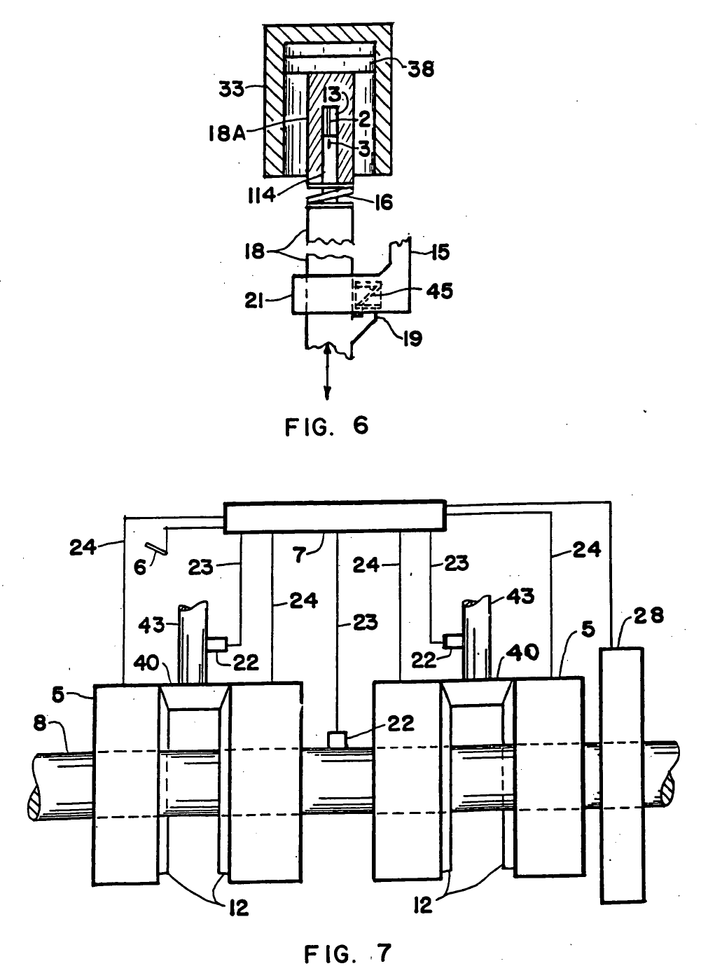

Piston 38 is always square in the cylinder 33 so wrist pins and piston skirts are not needed. The guide 21 is combined with a decelerator mechanism (FIG. 6) to stop piston 38 at or near top dead center. The decelerator includes a node 19 that is part of each rod 18 in a pair and a spring 45 for each node. The spring is shown encased in the guide 21 where an opening in the housing 15 allows easy replacement of the spring. The spring absorbs the impact of node 19 to halt the motion of piston 38, which is then accelerated on its power stroke by expanding combustion gases. The impact is reduced because node 19 is decelerating due to the power loss of the power piston to the shaft 8. The decelerator is positioned to prevent backlash in the gears 12 (FIGS. 3,4,5) that mesh with idler 40.

A computer 7 (FIG. 7) monitors input from the throttle 6 and shaft power from the sensor 22 on shaft 8 through leads 23 to determine the size of the combustion charge to transmit to the cylinders through injector lines 24. The position of piston 38 is monitored through sensors 22 on shaft 43 and used for ignition timing. Shifting shaft 43 (FIGS. 1,4) can shift the pistons until ignition. By monitoring the motion of each shaft 43 in several independent 2-stroke pairs, the computer controls timing between them. The computer begins a power stroke with a piston in one pair when a piston in another pair is partly through its power stroke (FIG. 9).

Interchanging 4-Stroke and 2-Stroke

In a 4-stroke, a sector gear 12 on each of two pairs engages idler 40A (FIG. 8). When changing from a 2-stroke to a 4-stroke, the pistons must be correctly positioned before engaging the idler with the sector gears. One of the correct positions is shown in FIG. 8 with 2 pistons at top dead center and 2 at bottom dead center.

To change from a 4-stroke to a 2-stroke, the special idler 40A is disengaged from sector gears 12 (FIG. 9). One of the relative positions of the active pistons under computer 7 control is shown in FIG. 9. Cylinder 1 begins its power stroke. Cylinder 2 begins its exhaust, intake stroke. Cylinder 3 is ½ way through its power stroke. Cylinder 4 is ½ way through its exhaust, intake stroke. 50% power stroke overlap and smooth rotation of the shaft 8 is gained. Greater overlap is gained with more pairs. Also, one pair of two pistons can be deactivated (stopped) without load on the engine to continue with a basic 2-stroke 2-cylinder engine.

Parabolic Reflector Cylinder Head

A drawing is believed not necessary to describe this embodiment. This invention's offset piston 10 (FIGS. 4,5) and r′ (FIG. 11) makes it effective. The entire cylinder head is a parabolic reflector with an igniter at its focus. The focus is at the end of a replaceable plug. An energy wave expands from the igniter to hit the parabolic reflector and the reflector directs the energy wave to uniformly impact the flat piston crown when the piston is at or near top dead center. The additional wave energy will help overcome inertia in reversing and accelerating both pistons 38 from zero where it is most effective in saving fuel.

Moderated Combustion Pressure

The extreme pressure and heat at and near tdc cause a crank engine's bypass gases. The gases, that often contain raw fuel, only dirty the crankcase oil and require frequent oil and filter changes. This inefficiency can be largely avoided in this engine.

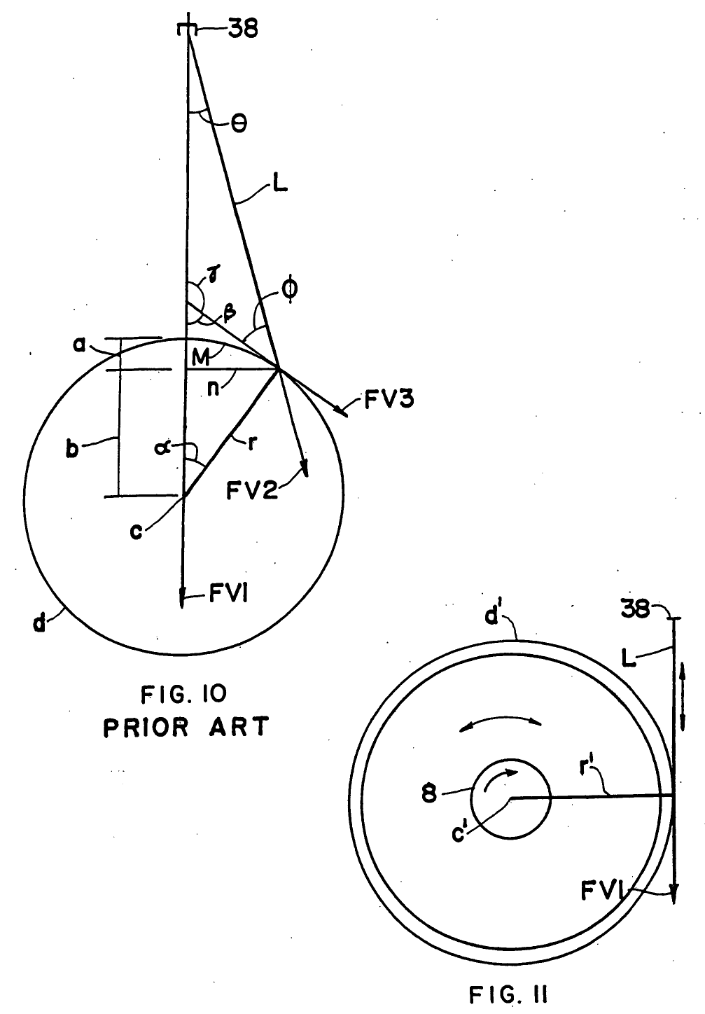

Rather than a large bore and short stroke, a small bore with a long stroke can be used with a lower volume expansion rate by controlling the peak piston pressure. But there is a further need to dynamically adjust the combustion's expansion rate to maintain the fuel's best burn pressure within a narrow range. This section describes two means to that end by absorbing excessive peak pressure in chamber 33. This invention's offset piston 10 (FIGS. 4,5) and r′ (FIG. 11) makes them effective. The crank engine cannot effectively exploit this fuel efficiency feature because the radial forces FV1 (FIG. 10) are directed against the shaft 8 axis to its immovable main bearings.

The first means replaces the single piece piston rod 18 (FIGS. 3,4) with a two-part piston rod 18 and 18A (FIG. 6) having a spring 16 between them. Spring 16 is connected to the two parts such that its compression and expansion are not affected. Rod part 18 has an extension 114 that extends through the center of spring 16 into a cylinder 13 in part 18A (shown in cross section) to keep the spring 16 centered on the axis of the two piston parts. Significant side thrust on the parts is not likely because the piston 38 is square in cylinder 33. There are two channels 2 on opposite sides of the cylinder 13 that are aligned with the axis of the cylinder. A small projection 3 on extension 114 reaches into each channel to prevent angular motion of part 18A and piston 38.

A second means includes a small, suitable flywheel 48 splined to the end of shaft 43 (FIG. 5). A conventional flywheel can be used but an alternative comprises three concentric parts. The inner part is splined to shaft 43. The outer part extends to the flywheel's rim. Between them is a tough, slightly elastic part that absorbs some of the initial ignition jolt to reduce stress on the engine's parts.

### BRIEF SUMMARY OF THE INVENTION

This is a high torque power engine that can be easily switched between a 2-stroke and a 4-stroke. A pair of combustion cylinders and their related pairs of parts, including 1-way clutches, are connected by an idler gear to make the basic 2-stroke engine. Computer controlled ignition between two basic engines allows power stroke overlap by equally spaced-apart pistons. A third idler connects two basic engines to make a 4-stroke engine. The crankshaft is replaced by a straight power shaft.

A 1-way clutch transmits power between the power piston and the output shaft. The piston is offset from the shaft at the point where it engages the piston rod. An alternative 1-way clutch that efficiently transmits torque is described in my U.S. Pat. No. 6,571,925 dated Jun. 3, 2003. This clutch will be emphasized over commercial 1-way clutches although commercial clutches are mentioned since they can be used with limitations.

There is no mechanical limit to the length of the piston stroke which allows benefits not found in crankshaft engines. One of the benefits is overlapping power strokes. For example: a 2-stroke, 6 cyl engine with a 9″ piston stroke would simultaneously have the 1^{st} piston 6″ after tdc, the 2^{nd} piston 3″ after tdc and the 3^{rd} piston igniting at tdc. The 6 pistons continuously cycle through their power strokes in this sequence. The power added by the 3^{rd} piston is reduced by the combined remaining power of the 1^{st} and 2^{nd} pistons resulting in fuel savings and smooth power shaft rotation.

Objects of this invention include:
1. easily interchanged between 2-stroke and 4-stroke;
2. no mechanical limit to the piston stroke allows sizing a more efficient combustion chamber;
3. offset pistons give instant peak torque at the beginning of the power stroke;
4. the 1-way clutch overrun feature allows deactivating pairs of pistons without load on the shaft;
5. reduced mass engine compared to a crank engine;
6. lightweight piston and rod due to compression forces only;
7. piston always square in its cylinder reduces cylinder wear and bypass gases;
8. power stroke overlap;
9. thin, straight power shaft due to shear force only;
10. fewer main bearings due to shear force only on the power shaft.

1. An engine comprising:
a power output means, an idler, a pair of work units, each work unit including a power piston wherein the power is transmitted to the power output means as the idler transmits motion between the power pistons.

2. The engine of claim 1 wherein the work unit includes a 1-way clutch.

3. The work unit of claim 2 which includes a rack and spur pinion.

4. The work unit of claim 2 wherein the 1-way clutch is secured directly to the power output means.

5. The 1-way clutch of claim 2 which comprises a rack gear.

6. The 1-way clutch of claim 2 which comprises a belt or equivalent chain.

7. The engine of claim 1 comprising a spring contacting a node when the pistons near top dead center.

8. The engine of claim 1 comprising a parabolic reflector cylinder head, an igniter at the focus of the reflector, the piston having a flat crown facing the reflector.

9. The engine of claim 1 comprising a spring loaded two-part piston rod and a combustion cylinder wherein combustion pressure in said combustion cylinder is moderated.

10. The engine of claim 1 comprising a flywheel and a combustion cylinder wherein the flywheel moderates combustion pressure in said combustion cylinder.

11. The engine of claim 1 which includes more than one independent pairs of the work units wherein the pistons cycle through power stroke overlap.

12. The engine of claim 1 which includes more than one independent pairs of the work units and means for selectively activating and deactivating the pairs.

13. The engine of claim 1 which includes two independent pairs that comprise a 2-stroke wherein the idler engaging the two independent pairs effects a 4-stroke engine and a disengagement of the idler reverts back to a 2-stroke.

14. The 1-way clutch of claim 2 which includes a belt, a lever arm contact surface comprising protrusions wherein the protrusions contact the belt to transmit torque between the race and a hub and disconnect during overrun to prevent the transmission.

15. The 1-way clutch of claim 14 in which the lever arm contact surface bridges a space between the belt and the hub wherein torque is transmitted directly through the lever contact surface to the hub.

16. The 1-way clutch of claim 2 which includes;
a side plate, the side plate including a gear and the idler engaging the gear.

17. A 1-way clutch which includes a side plate, the side plate including a gear and an idler engaging the gear.
